(19) United States
(12) Patent Application Publication
(10) Pub. No.: US 2009/0055831 A1
(43) Pub. Date: Feb. 26, 2009

(54) Allocating Network Adapter Resources Among Logical Partitions

(76) Inventors: Ellen M. Bauman, Rochester, MN (US); Shawn M. Lambeth, Pine Island, MN (US); Timothy J. Schimke, Stewartville, MN (US); Lee A. Sendelbach, Rochester, MN (US)

Correspondence Address: IBM CORPORATION;ROCHESTER IP LAW DEPT. 917, 3605 HIGHWAY 52 NORTH, ROCHESTER, MN, 55901-7829, US

(21) Appl. No.: 11/844,434

(22) Filed: Aug. 24, 2007

(51) Int. Cl. G06F 9/455

(52) U.S. Cl. 718/104

(57) ABSTRACT

In an embodiment, a network adapter has a physical port that is multiplexed to multiple logical ports, which have default queues. The adapter also has other queues, which can be allocated to any logical port, and resources, which map tuples to queues. The tuples are derived from data in packets received via the physical port. The adapter determines which queue should receive a packet based on the received tuple and the resources. If the received tuple matches a resource, then the adapter stores the packet to the corresponding queue; otherwise, the adapter stores the packet to the default queue for the logical port specified by the packet. In response to receiving an allocation request from a requesting partition, if no resources are idle, a resource is selected for preemption that is already allocated to a selected partition. The selected resource is then allocated to the requesting partition.

### FIELD

An embodiment of the invention generally relates to allocating the resources of a network adapter among multiple partitions in a logically-partitioned computer.

### BACKGROUND

The development of the EDVAC computer system of 1948 is often cited as the beginning of the computer era. Since that time, computer systems have evolved into extremely sophisticated devices. Computer systems typically include a combination of hardware (e.g., semiconductors, circuit boards, etc.) and software (e.g., computer programs). As advances in semiconductor processing and computer architecture push the performance of the computer hardware higher, more sophisticated computer software has evolved to take advantage of the higher performance of the hardware, resulting in computer systems today that are much more powerful than just a few years ago. One advance in computer technology is the development of parallel processing, i.e., the performance of multiple tasks in parallel.

A number of computer software and hardware technologies have been developed to facilitate increased parallel processing. From a hardware standpoint, computers increasingly rely on multiple microprocessors to provide increased workload capacity. From a software standpoint, multithreaded operating systems and kernels have been developed, which permit computer programs to concurrently execute in multiple threads, so that multiple tasks can essentially be performed at the same time. In addition, some computers implement the concept of logical partitioning, where a single physical computer is permitted to operate essentially like multiple and independent virtual computers, referred to as logical partitions, with the various resources in the physical computer (e.g., processors, memory, adapters, and input/output devices) allocated among the various logical partitions via a partition manager, or hypervisor. Each logical partition executes a separate operating system, and from the perspective of users and of the software applications executing in the logical partition, operates as a fully independent computer.

Because each logical partition is essentially competing with other logical partitions for the limited resources of the computer, and the needs of each logical partition may change over time, one challenge in a logically partitioned system is to dynamically allocate resources to the partitions, so that the partitions share the limited resources of the computer system. One resource that is often shared by multiple partitions is a network adapter. A network adapter connects the computer system (and the partitions that share it) to a network, so that the partitions may communicate with other systems that are also connected to the network. A network adapter typically connects to the network via one or more physical ports, each having a network address. The network adapter sends packets of data to the network via its physical ports and receives packets of data from the network if those packets specify its physical port address.

Because many logical partitions are often active, many different sessions are also concurrently active on a given network adapter. It is desirable for the network adapter to sort the incoming traffic of packets, such that the required hypervisor processing of the packets is reduced, and the packets are directly routed to the application in the partition that is waiting for them. Because each partition usually needs network connectivity, at least temporarily, but each partition does not necessarily require the full bandwidth of a physical port at all times, partitions often share a physical port. This sharing is implemented by the network adapter multiplexing one (or more) physical port into multiple logical ports, each allocated to a single partition. Thus, each logical partition is allocated a logical network adapter and a logical port, and each logical partition uses its logical network adapter and logical port just as it would a dedicated stand-alone physical adapter and physical port.

The routing of packets to their target partitions using the logical ports is sometimes implemented via queue pairs (QPs). Each logical port is given, or assigned, one queue pair (a send queue and a receive queue), which acts as the default queue pair for incoming packets. When the network adapter receives a packet from the network, the adapter performs a lookup of the target logical port address and routes the incoming packet to the appropriate queue pair based upon that logical port address.

Some network adapters also provide a mechanism known as “per connection queuing” to accelerate the decode and sorting of the packets. The network adapter allocates additional queue pairs, onto which the network adapter can place incoming packets. A mapping table facilitates this routing. Included in the mapping table are a “tuple” and an indication of to which queue pair the packets associated with that tuple are to be delivered. A tuple is a combination of various network and destination addresses, which uniquely identifies a session. Usage of the tuple allows the network adapter to sort the packets into different queue pairs automatically, which then allows partitions to immediately begin processing without first requiring lengthy preprocessing (which might be lengthy) to sort the incoming packets. The problem is that the network adapter only supports a fixed number of the records (resources) in the mapping table, and these resources must be shared among the logical partitions.

One current technique for sharing the resources is a dedicated fixed allocation of the available resources to the partitions. This technique has the drawback that often many of the resources will be unused, e.g., because a given partition is not currently activated, is idle, or is relatively less busy, so that the partition does not require its full allocation of resources. Yet, other partitions may be more busy and could use those idle resources to accelerate their important work if only the idle resources could be allocated to them.

A second current technique attempts to monitor the usage of resources by the partitions and to reassign the resources, as the needs of the partitions change. This technique has several drawbacks. First, it requires a real-time (or at least timely) monitoring of the current usage of the resources. Second, the desired usage (e.g., a partition might desire more than its current allocation of resources) also needs to be determined, which may require ongoing communication with each of the partitions. Third, problems may occur with transient resource requirements, in that sufficient latency may exist such that the resource requirements will change again prior to the ability to effect changes in the resource allocations. Fourth, determining the relative value of the resources assigned to different partitions is difficult. Finally, determining how to most efficiently allocate the resources is difficult to achieve because different partitions may have different goals and different priorities. For example, one partition might desire to reduce latency while another partition might desire to increase throughput. As another example, one partition might use the resource to perform valuable work while another partition performs work that is less valuable or uses its resource simply because it is available, and that resource might be put to better use at a different partition.

Thus, what is needed is an enhanced technique that more efficiently utilizes the available resources of the network adapter across all partitions.

### SUMMARY

A method, apparatus, system, and storage medium are provided. In an embodiment, a first allocation request is received from a requesting partition. The first allocation request includes a tuple, an identifier of a queue, and a first priority. In response to receiving the first allocation request, if no resources are idle, a resource is selected that is already allocated to a selected partition at a second priority. The selected resource is then allocated to the requesting partition. The allocation includes storing a mapping of the tuple to the queue into the selected resource. In an embodiment, the resource is selected by determining that the first priority of the allocation request is greater than the second priority of the allocation to the selected partition and by determining that the selected partition is allocated a greatest percentage of its allocated resources at the second priority, as compared to percentages of resources allocated at the second priority to other partitions, where the second priority is the lowest priority of the allocated resources. In another embodiment, the resource is selected by determining that the first priority is less than or equal to priorities of all resources that are currently allocated and by determining that the requesting partition has a percentage of its upper limit of resources allocated at the first priority that is less than the percentage of the selected partition's upper limit of resources allocated at the second priority, where the second priority is identical to the first priority. In this way, in an embodiment, resources are more effectively allocated to partitions, which increases the performance of packet processing.

### BRIEF DESCRIPTION OF THE DRAWINGS

Various embodiments of the present invention are hereinafter described in conjunction with the appended drawings:

FIG. 1 depicts a high-level block diagram of an example system for implementing an embodiment of the invention.

FIG. 2 depicts a block diagram of an example network adapter, according to an embodiment of the invention.

FIG. 3 depicts a block diagram of an example partition, according to an embodiment of the invention.

FIG. 4 depicts a block diagram of an example data structure for a configuration request, according to an embodiment of the invention.

FIG. 5 depicts a block diagram of an example data structure for resource limits, according to an embodiment of the invention.

FIG. 6 depicts a block diagram of an example data structure for configuration data, according to an embodiment of the invention.

FIG. 7 depicts a flowchart of example processing for configuration and activation requests, according to an embodiment of the invention.

FIG. 8 depicts a flowchart of example processing for an allocation request, according to an embodiment of the invention.

FIG. 9 depicts a flowchart of example processing for determining whether an allocated resource should be preempted, according to an embodiment of the invention.

FIG. 10 depicts a flowchart of example processing for preempting the allocation of a resource, according to an embodiment of the invention.

FIG. 11 depicts a flowchart of example processing for deallocating a resource, according to an embodiment of the invention.

FIG. 12 depicts a flowchart of example processing for receiving a packet, according to an embodiment of the invention.

FIG. 13 depicts a flowchart of example processing for deactivating a partition, according to an embodiment of the invention.

FIG. 14 depicts a flowchart of example processing for handling a saved allocation request, according to an embodiment of the invention.

It is to be noted, however, that the appended drawings illustrate only example embodiments of the invention, and are therefore not considered limiting of its scope, for the invention may admit to other equally effective embodiments.

### DETAILED DESCRIPTION

In an embodiment, a network adapter has a physical port that is multiplexed to multiple logical ports. Each logical port has a default queue. The network adapter also has additional queues that can be allocated to any logical port. The network adapter has a table of mappings, also known as resources, between tuples and queues. The tuples are derived from a combination of data in fields of the packets. The network adapter determines whether the default queue or another queue should receive a packet based on the tuple in the packet and the resources in the table. If the tuple derived from the incoming packet matches a tuple in the table, then the network adapter routes the packet to the corresponding specified queue for that tuple; otherwise, the network adapter routes the packet to the default queue for the logical port specified by the packet. Partitions request allocation of the resources for the queues and the tuples by sending allocation requests to a hypervisor. If no resources are idle or unallocated, a resource already allocated is selected and its allocation is preempted, so that the selected resource can be allocated to the requesting partition. In this way, in an embodiment, resources are more effectively allocated to partitions, which increases the performance of packet processing.

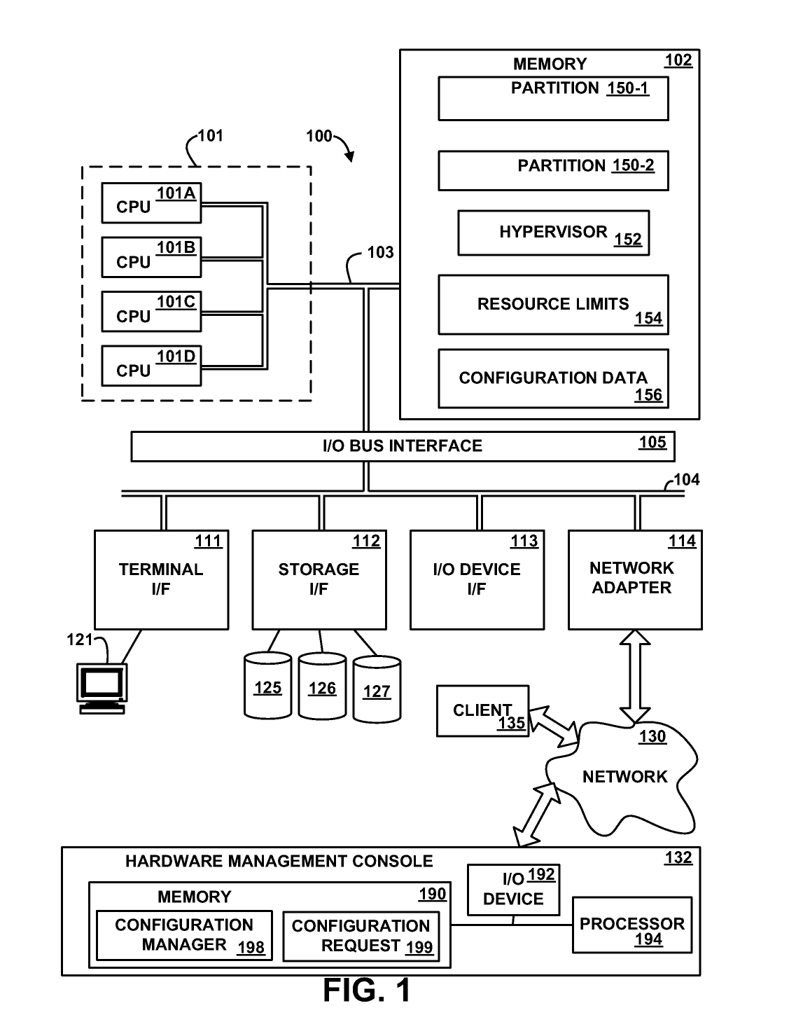

Referring to the Drawings, wherein like numbers denote like parts throughout the several views, FIG. 1 depicts a high-level block diagram representation of a server computer system 100 connected to a hardware management console computer system 132 and a client computer system 135 via a network 130, according to an embodiment of the present invention. The terms “client” and “server” are used herein for convenience only, and in various embodiments a computer system that operates as a client in one environment may operate as a server in another environment, and vice versa. In an embodiment, the hardware components of the computer systems 100, 132, and 135 may be implemented by IBM System i5 computer systems available from International Business Machines Corporation of Armonk, N.Y. But, those skilled in the art will appreciate that the mechanisms and apparatus of embodiments of the present invention apply equally to any appropriate computing system.

The major components of the computer system 100 include one or more processors 101, a main memory 102, a terminal interface 111, a storage interface 112, an I/0 (Input/Output) device interface 113, and a network adapter 114, all of which are communicatively coupled, directly or indirectly, for inter-component communication via a memory bus 103, an I/0 bus 104, and an I/0 bus interface unit 105.

The computer system 100 contains one or more general-purpose programmable central processing units (CPUs) 101A, 101B, 101C, and 101D, herein generically referred to as the processor 101. In an embodiment, the computer system 100 contains multiple processors typical of a relatively large system; however, in another embodiment the computer system 100 may alternatively be a single CPU system. Each processor 101 executes instructions stored in the main memory 102 and may include one or more levels of on-board cache.

The main memory 102 is a random-access semiconductor memory for storing or encoding data and programs. In another embodiment, the main memory 102 represents the entire virtual memory of the computer system 100, and may also include the virtual memory of other computer systems coupled to the computer system 100 or connected via the network 130. The main memory 102 is conceptually a single monolithic entity, but in other embodiments the main memory 102 is a more complex arrangement, such as a hierarchy of caches and other memory devices. For example, memory may exist in multiple levels of caches, and these caches may be further divided by function, so that one cache holds instructions while another holds non-instruction data, which is used by the processor or processors. Memory may be further distributed and associated with different CPUs or sets of CPUs, as is known in any of various so-called non-uniform memory access (NUMA) computer architectures.

The main memory 102 stores or encodes partitions 150-1 and 150-2, a hypervisor 152, resource limits 154, and configuration data 156. Although the partitions 150-1 and 150-2, the hypervisor 152, the resource limits 154, and the configuration data 156 are illustrated as being contained within the memory 102 in the computer system 100, in other embodiments some or all of them may be on different computer systems and may be accessed remotely, e.g., via the network 130. The computer system 100 may use virtual addressing mechanisms that allow the programs of the computer system 100 to behave as if they only have access to a large, single storage entity instead of access to multiple, smaller storage entities. Thus, while the partitions 150-1 and 150-2, the hypervisor 152, the resource limits 154, and the configuration data 156 are illustrated as being contained within the main memory 102, these elements are not necessarily all completely contained in the same storage device at the same time. Further, although the partitions 150-1 and 150-2, the hypervisor 152, the resource limits 154, and the configuration data 156 are illustrated as being separate entities, in other embodiments some of them, portions of some of them, or all of them may be packaged together.

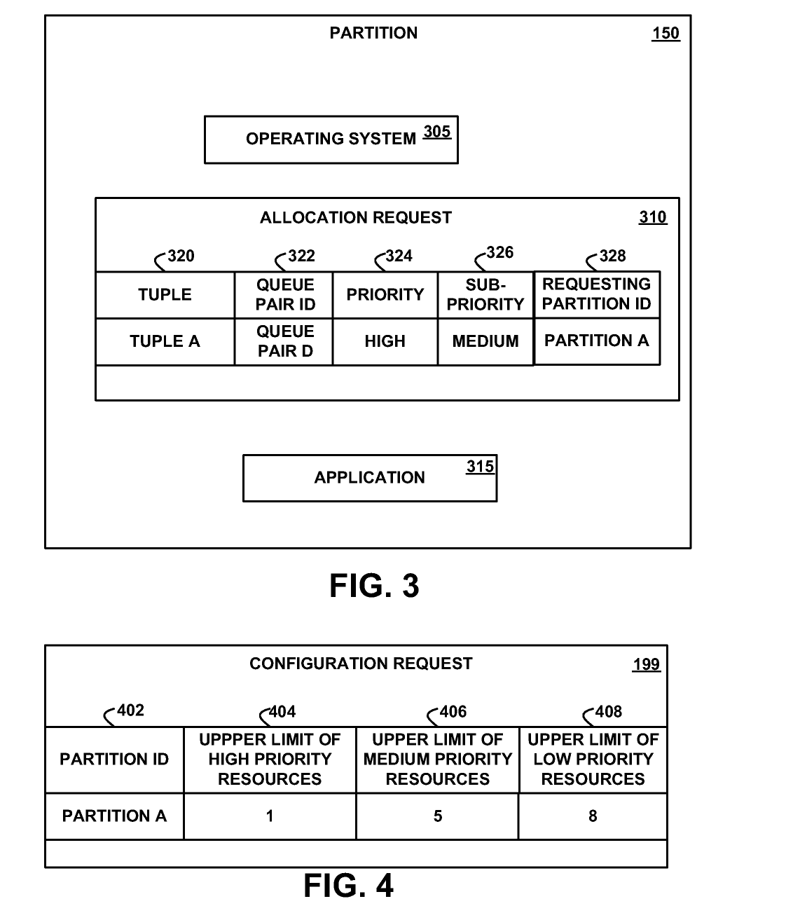

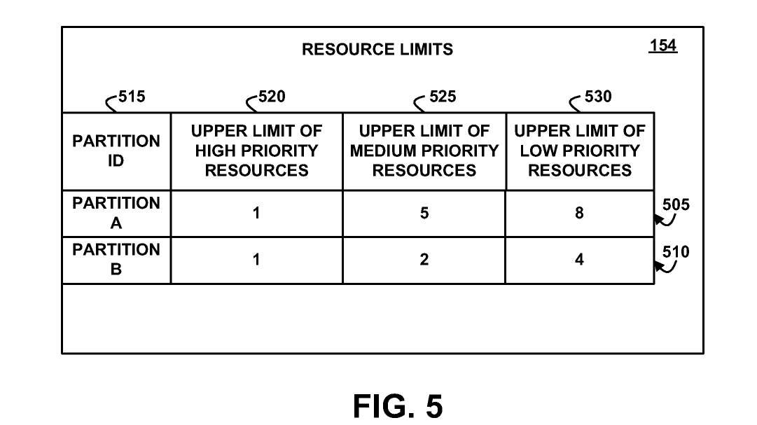

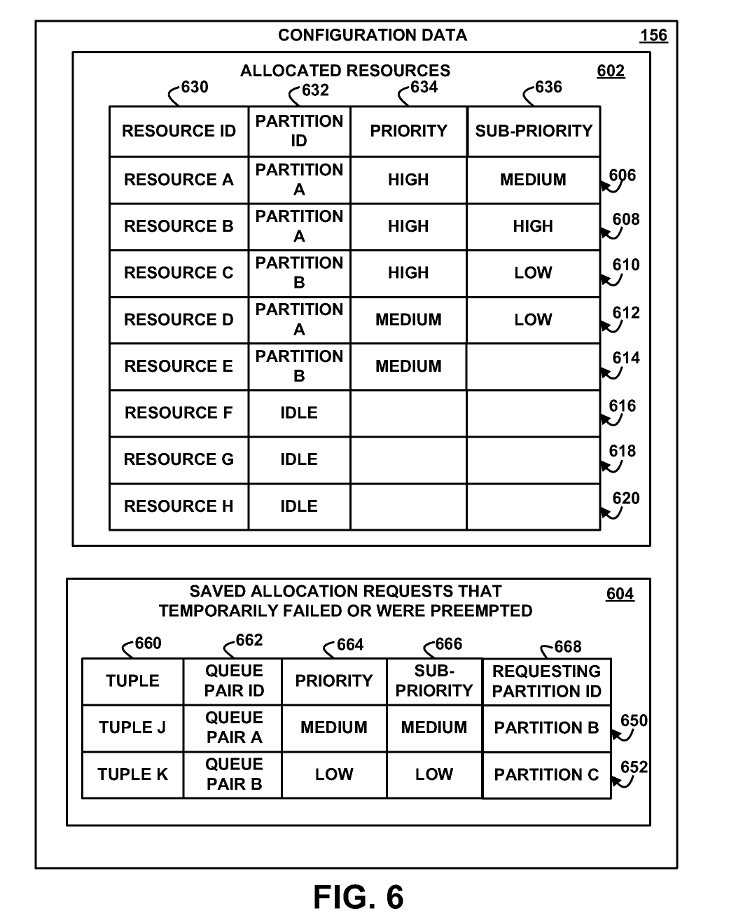

The partitions 150-1 and 150-2 are further described below with reference to FIG. 3. The hypervisor 152 activates the partitions 150-1 and 150-2 and allocates resources to the partitions 150-1 and 150-2 using the resource limits 154 and the configuration data 156, in response to requests from the hardware management console 132. The resource limits 154 are further described below with reference to FIG. 5. The configuration data 156 is further described below with reference to FIG. 6.

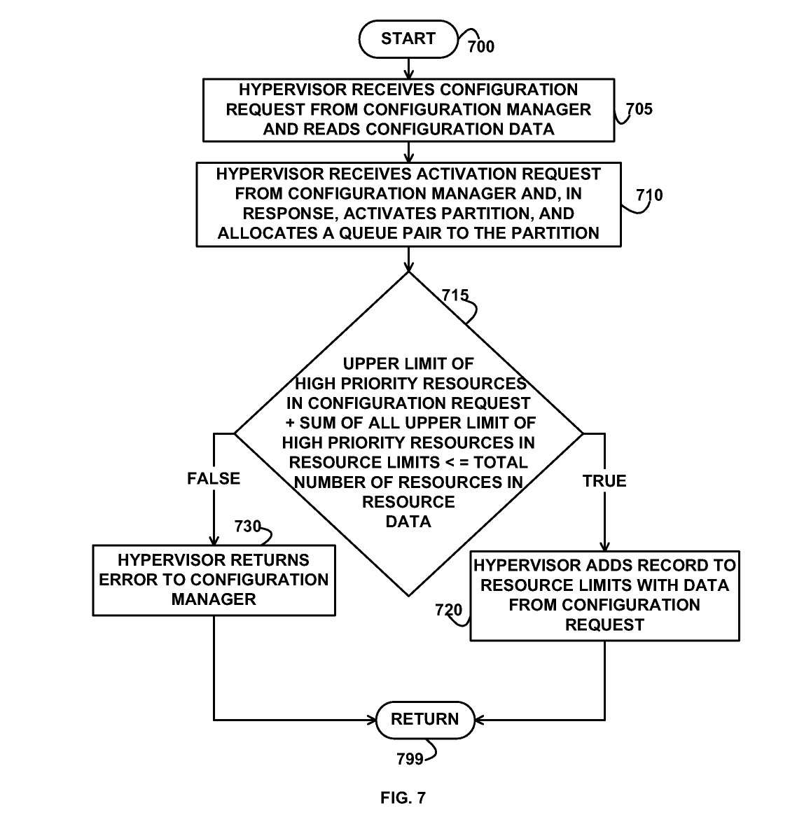

In an embodiment, the hypervisor 152 includes instructions capable of executing on the processor 101 or statements capable of being interpreted by instructions that execute on the processor 101, to carry out the functions as further described below with reference to FIGS. 7, 8, 9, 10, 11, 12, 13, and 14. In another embodiment, the hypervisor 152 is implemented in hardware via logical gates and other hardware devices in lieu of, or in addition to, a processor-based system.

The memory bus 103 provides a data communication path for transferring data among the processor 101, the main memory 102, and the I/O bus interface unit 105. The I/O bus interface unit 105 is further coupled to the system I/O bus 104 for transferring data to and from the various I/O units. The I/O bus interface unit 105 communicates with multiple I/O interface units 111, 112, 113, and 114, which are also known as I/O processors (IOPs) or I/O adapters (IOAs), through the system I/O bus 104. The system I/O bus 104 may be, e.g., an industry standard PCI (Peripheral Component Interface) bus, or any other appropriate bus technology.

The I/O interface units support communication with a variety of storage and I/O devices. For example, the terminal interface unit 111 supports the attachment of one or more user terminals 121, which may include user output devices (such as a video display device, speaker, and/or television set) and user input devices (such as a keyboard, mouse, keypad, touchpad, trackball, buttons, light pen, or other pointing device).

The storage interface unit 112 supports the attachment of one or more direct access storage devices (DASD) 125, 126, and 127 (which are typically rotating magnetic disk drive storage devices, although they could alternatively be other devices, including arrays of disk drives configured to appear as a single large storage device to a host). The contents of the main memory 102 may be stored to and retrieved from the direct access storage devices 125, 126, and 127, as needed.

The I/O device interface 113 provides an interface to any of various other input/output devices or devices of other types, such as printers or fax machines. The network adapter 114 provides one or more communications paths from the computer system 100 to other digital devices and computer systems 132 and 135; such paths may include, e.g., one or more networks 130.

Although the memory bus 103 is shown in FIG. 1 as a relatively simple, single bus structure providing a direct communication path among the processors 101, the main memory 102, and the I/O bus interface 105, in fact the memory bus 103 may comprise multiple different buses or communication paths, which may be arranged in any of various forms, such as point-to-point links in hierarchical, star or web configurations, multiple hierarchical buses, parallel and redundant paths, or any other appropriate type of configuration. Furthermore, while the I/O bus interface 105 and the I/O bus 104 are shown as single respective units, the computer system 100 may in fact contain multiple I/O bus interface units 105 and/or multiple I/O buses 104. While multiple I/O interface units are shown, which separate the system I/O bus 104 from various communications paths running to the various I/O devices, in other embodiments some or all of the I/O devices are connected directly to one or more system I/O buses.

In various embodiments, the computer system 100 may be a multi-user “mainframe” computer system, a single-user system, or a server or similar device that has little or no direct user interface, but receives requests from other computer systems (clients). In other embodiments, the computer system 100 may be implemented as a personal computer, portable computer, laptop or notebook computer, PDA (Personal Digital Assistant), tablet computer, pocket computer, telephone, pager, automobile, teleconferencing system, appliance, or any other appropriate type of electronic device.

The network 130 may be any suitable network or combination of networks and may support any appropriate protocol suitable for communication of data and/or code to/from the computer system 100, the hardware management console 132, and the client computer systems 135. In various embodiments, the network 130 may represent a storage device or a combination of storage devices, either connected directly or indirectly to the computer system 100. In an embodiment, the network 130 may support the Infiniband architecture. In another embodiment, the network 130 may support wireless communications. In another embodiment, the network 130 may support hard-wired communications, such as a telephone line or cable. In another embodiment, the network 130 may support the Ethernet IEEE (Institute of Electrical and Electronics Engineers) 802.3 specification. In another embodiment, the network 130 may be the Internet and may support IP (Internet Protocol).

In another embodiment, the network 130 may be a local area network (LAN) or a wide area network (WAN). In another embodiment, the network 130 may be a hotspot service provider network. In another embodiment, the network 130 may be an intranet. In another embodiment, the network 130 may be a GPRS (General Packet Radio Service) network. In another embodiment, the network 130 may be a FRS (Family Radio Service) network. In another embodiment, the network 130 may be any appropriate cellular data network or cell-based radio network technology. In another embodiment, the network 130 may be an IEEE 802.11B wireless network. In still another embodiment, the network 130 may be any suitable network or combination of networks. Although one network 130 is shown, in other embodiments any number of networks (of the same or different types) may be present.

The client computer system 135 may include some or all of the hardware components previously described above as being included in the server computer system 100. The client computer system 135 sends packets of data to the partitions 150-1 and 150-2 via the network 130 and the network adapter 114. In various embodiments, the packets of data may include video, audio, text, graphics, images, frames, pages, code, programs, or any other appropriate data.

The hardware management console 132 may include some or all of the hardware components previously described above as being included in the server computer system 100. In particular, the hardware management console 132 includes memory 190 connected to an I/O device 192 and a processor 194. The memory 190 includes a configuration manager 198 and a configuration request 199. In another embodiment, the configuration manager 198 and the configuration request 199 may be stored in the memory 102 of the server computer system 100, and the configuration manger 198 may execute on the processor 101. The configuration manager 198 sends the configuration request 199 to the server computer system 100. The configuration request 199 is further described below with reference to FIG. 4.

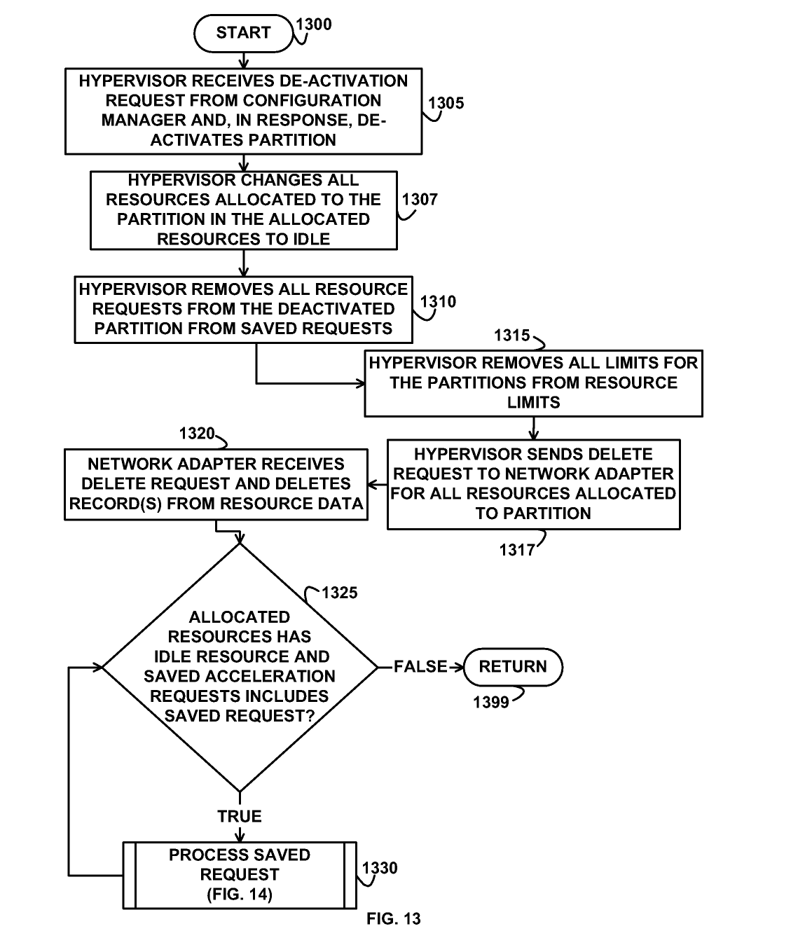

In an embodiment, the configuration manager 198 includes instructions capable of executing on the processor 194 or statements capable of being interpreted by instructions that execute on the processor 194, to carry out the functions as further described below with reference to FIGS. 7 and 13. In another embodiment, the configuration manager 198 is implemented in hardware via logical gates and other hardware devices in lieu of, or in addition to, a processor-based system.

It should be understood that FIG. 1 is intended to depict the representative major components of the server computer system 100, the network 130, the hardware management console 132, and the client computer systems 135 at a high level, that individual components may have greater complexity than represented in FIG. 1, that components other than or in addition to those shown in FIG. 1 may be present, and that the number, type, and configuration of such components may vary. Several particular examples of such additional complexity or additional variations are disclosed herein; it being understood that these are by way of example only and are not necessarily the only such variations.

The various software components illustrated in FIG. 1 and implementing various embodiments of the invention may be implemented in a number of manners, including using various computer software applications, routines, components, programs, objects, modules, data structures, etc., and are referred to hereinafter as “computer programs,” or simply “programs.” The computer programs typically comprise one or more instructions that are resident at various times in various memory and storage devices in the server computer system 100 and/or the hardware management console 132, and that, when read and executed by one or more processors in the server computer system 100 and/or the hardware management console 132, cause the server computer system 100 and/or the hardware management console 132 to perform the steps necessary to execute steps or elements comprising the various aspects of an embodiment of the invention.

Moreover, while embodiments of the invention have and hereinafter will be described in the context of fully-functioning computer systems, the various embodiments of the invention are capable of being distributed as a program product in a variety of forms, and the invention applies equally regardless of the particular type of signal-bearing medium used to actually carry out the distribution. The programs defining the functions of this embodiment may be delivered to the server computer system 100 and/or the hardware management console 132 via a variety of tangible signal-bearing media that may be operatively or communicatively connected (directly or indirectly) to the processor or processors, such as the processor 101 and 194. The signal-bearing media may include, but are not limited to:

(1) information permanently stored on a non-rewriteable storage medium, e.g., a read-only memory device attached to or within a computer system, such as a CD-ROM readable by a CD-ROM drive;

(2) alterable information stored on a rewriteable storage medium, e.g., a hard disk drive (e.g., DASD 125, 126, or 127), the main memory 102 or 190, CD-RW, or diskette; or

(3) information conveyed to the server computer system 100 and/or the hardware management console 132 by a communications medium, such as through a computer or a telephone network, e.g., the network 130.

Such tangible signal-bearing media, when encoded with or carrying computer-readable and executable instructions that direct the functions of the present invention, represent embodiments of the present invention.

Embodiments of the present invention may also be delivered as part of a service engagement with a client corporation, nonprofit organization, government entity, internal organizational structure, or the like. Aspects of these embodiments may include configuring a computer system to perform, and deploying computing services (e.g., computer-readable code, hardware, and web services) that implement, some or all of the methods described herein. Aspects of these embodiments may also include analyzing the client company, creating recommendations responsive to the analysis, generating computer-readable code to implement portions of the recommendations, integrating the computer-readable code into existing processes, computer systems, and computing infrastructure, metering use of the methods and systems described herein, allocating expenses to users, and billing users for their use of these methods and systems.

In addition, various programs described hereinafter may be identified based upon the application for which they are implemented in a specific embodiment of the invention. But, any particular program nomenclature that follows is used merely for convenience, and thus embodiments of the invention should not be limited to use solely in any specific application identified and/or implied by such nomenclature.

The exemplary environments illustrated in FIG. 1 are not intended to limit the present invention. Indeed, other alternative hardware and/or software environments may be used without departing from the scope of the invention.

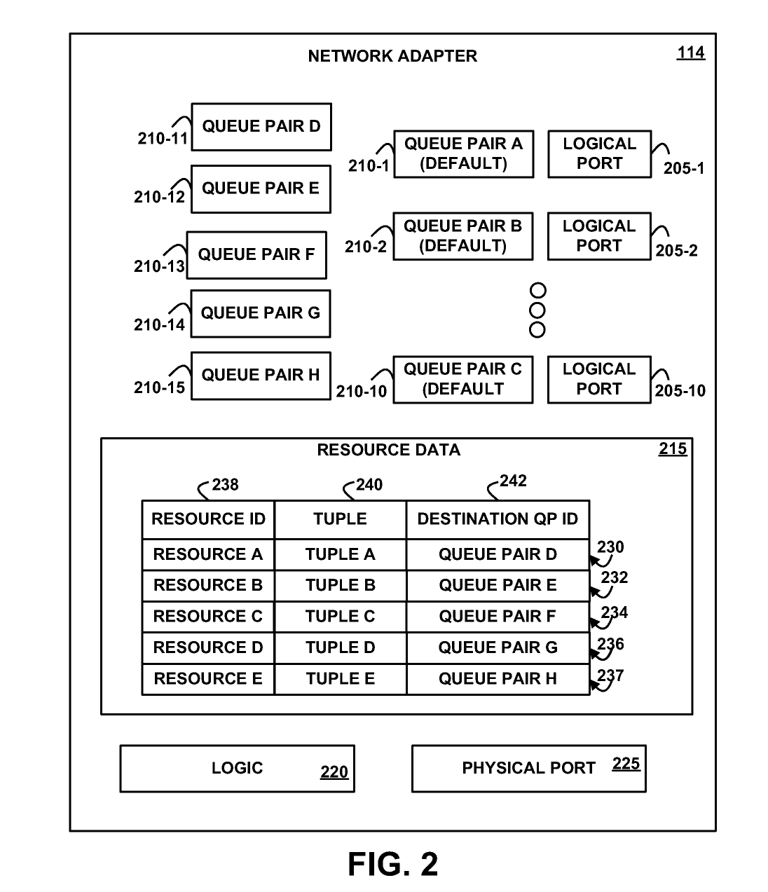

FIG. 2 depicts a block diagram of an example network adapter 114, according to an embodiment of the invention. The network adapter 114 includes (is connected to) queue pairs 210-1 210-2, 210-10, 210-11, 210-12, 210-13, 210-14, and 210-15. The network adapter 114 further includes (is connected to) logical ports 205-1, 205-2, and 205-10. The network adapter 114 further includes (is connected to) resource data 215, logic 220, and a physical port 225. The logic 220 is connected to the physical port 225, the resource data 215, the logical ports 205-1, 205-2, and 205-10 and the queue pairs 210-1, 210-2, 210-10, 210-11, 210-12, 210-13, 210-14, and 210-15.

In various embodiments, the queue pairs 210-1, 210-2, 210-10, 210-11, 210-12, 210-13, 210-14, and 210-15, the logical ports 205-1, 205-2, and 205-10, and the resource data 215 may be implemented via memory locations and/or registers. The logic 220 includes hardware that may be implemented by logic gates, modules, circuits, chips, or other hardware components. In other embodiments, the logic 220 may be implemented by microcode, instructions, or statements stored in memory and executed on a processor.

The physical port 225 provides a physical interface between the network adapter 114 and other computers or devices that form a part of the network 130. The physical port 225 is an outlet or other piece of equipment to which a plug or cable connects. Electronically, several conductors making up the outlet provide a signal transfer between the network adapter 114 and the devices of the network 130. In various embodiments, the physical port 225 may be implemented via a male port (with protruding pins) or a female port (with a receptacle designed to receive the protruding pins of a cable). In various embodiments, the physical port 225 may have a variety of shapes, such as round, rectangular, square, trapezoidal, or any other appropriate shape. In various embodiments, the physical port 225 may be a serial port or a parallel port. A serial port sends and receives one bit at a time via a single wire pair (e.g., ground and ±). A parallel port sends and receives multiple bits at the same time over several sets of wires.

After the physical port 225 is connected to the network 130, the network adapter 114 typically requires “handshaking,” which is a similar concept to the negotiation that occurs when two fax machines make a connection, where transfer type, transfer rate, and other necessary information is shared even before data are sent. In an embodiment, the physical port 225 is hot-pluggable, meaning that the physical port 225 may be plugged in or connected to the network 130 while the network adapter 114 is already powered on (receiving electrical power). In an embodiment, the physical port 225 provides a plug-and-play function, meaning that the logic 220 of the network adapter 114 is designed so that the network adapter 114 and the connected devices automatically start handshaking as soon as the hot-plugging is done. In an embodiment, special software (called a driver) must be loaded into the network adapter 114, to allow communication (correct signals) for certain devices.

The physical port 225 has an associated physical network address. The physical port 225 receives, from the network 130, those packets that include the physical network address of the physical port 225. The logic 220 then sends or routes the packet to the logical port whose logical network address is specified in the packet. Thus, the logic 220 multiplexes the single physical port 225 to create the multiple logical ports 205-1, 205-2, and 205-10. In an embodiment, the logical ports 205-1, 205-2, and 205-10 are logical Ethernet ports, and each has a distinct Ethernet MAC (Media Access Control) address. Each partition (operating system or application) is the sole owner of, and has exclusive access to, its particular logical port. The partition (operating system instance or application) then retrieves the packet from the queue pair that is associated with the logical port owned by that partition. The queue pair from which the partition retrieves the packet may be the default queue pair (210-1, 210-2, or 210-10) associated with the logical port or another queue pair (210-11, 210-12, 210-13, 210-14, or 210-15) that the logic 220 temporarily assigns to the logical port via the resource data 215.

The queue pairs 210-1, 210-2, 210-10, 210-11, 210-12, 210-13, 210-14, and 210-15 are the logical endpoints of communication links. A queue pair is a memory-based abstraction where communication is achieved through direct memory-to-memory transfers between applications and devices. A queue pair includes a send and a receive queue of work requests (WR). In another embodiment, the queue pair construct is not necessary, and a send queue and a receive queue may be packaged separately. Each work request contains the necessary data for the message transaction including pointers into registered buffers to receive/transmit data between the network adapter 114 and the network 130.

In an embodiment, the queue pair model has two classes of message transactions: send-receive and remote DMA (Direct Memory Access). To conduct transfers, the application or operating system in a partition 150-1 or 150-2 constructs a work request and posts it to the queue pair that is allocated to the partition and the logical port. The posting method adds the work request to the appropriate queue pair and notifies the logic 220 in the network adapter 114 of a pending operation. In the send-receive paradigm, the target partition pre-posts receive work requests that identify memory regions where incoming data will be placed. The source partition posts a send work request that identifies the data to send. Each send operation on the source partition consumes a receive work request on the target partition. In this scheme, each application or operating system in the partition manages its own buffer space and neither end of the message transaction has explicit information about the peer's registered buffers. In contrast, remote DMA messages identify both the source and target buffers. Data can be directly written to or read from a remote address space without involving the target partition.

The resource data 215 includes example records 230, 232, 234, 236, and 237. In an embodiment, the resource data 215 has a fixed size and a maximum number of records, so that searches of the resource data 215 can complete quickly enough to keep up with the incoming stream of packets from the network 130. The entries or records in the resource data 215 (e.g., the records 230, 232, 234, 236, and 237) are the resources that are allocated amongst the logical partitions 150-1 and 150-2. Each of the records 230, 232, 234, 236, and 237 includes a resource identifier field 238, an associated tuple field 240, and an associated destination queue pair identifier field 242. The resource identifier field 238 identifies the record, or resource. The tuple field 240 includes data that is a property of some packet(s) and, in various embodiments, may include data from a field of the some received or anticipated to be received packet(s) or a combination of fields of the packet(s). In various embodiments, the tuple 240 may include the network (e.g., the IP or Internet Protocol address) of the source computer system 135 that sent the packet(s), the network address (e.g., the IP or Internet Protocol address) of the destination of the packet(s) (e.g., the network address of the physical port 225), the TCP/UDP (Transmission Control Protocol/User Datagram Protocol) source port, the TCP/UDP destination port, the transmission protocol used to transmit the packet(s), or the logical port identifier that identifies the logical port 205-1, 205-2, or 205-10 that is the destination of the packet(s).

The destination queue pair identifier field 242 identifies the queue pair that is to receive the packet that is identified by the tuple 240. Thus, each of the records (resources) in the resource data 215 represents a mapping or an association between the data in the tuple field 240 and the data in the destination queue pair field 242. If the tuple derived from the received packet matches a tuple 240 in a record (resource) in the resource data 215, then the logic 220 routes, sends, or stores that packet to the corresponding specified destination queue pair 242 associated with that tuple 240 in that record (resource). For example, if the tuple derived from the received packet is “tuple B,” then the logic 220 determines that “tuple B” is specified in the tuple field 240 of the record 232, and “queue pair E” is specified in the corresponding destination queue pair identifier field 242 in the record 232, so the logic 220 routes, sends, or stores that received packet to the queue pair E 210-12.

If the tuple derived from the incoming packet does not match any tuple 240 in any record (resource) in the resource data 215, then the logic 220 routes, sends, or stores that packet to the default queue pair associated with (or assigned to) the logical port that is specified in the packet. For example, the queue pair 210-1 is the default queue pair assigned to the logical port 205-1; the queue pair 210-2 is the default queue pair assigned to the logical port 205-2; and the queue pair 210-10 is the default queue pair assigned to the logical port 205-10. Thus, for example, if the tuple derived from the received packet is “tuple F,” then the logic 220 determines that “tuple F” is not specified in the tuple field 240 of any record (resource) in the resource data 215, so the logic 220 routes, sends, or stores that received packet to the queue pair 210-1, 210-2, or 210-10 that is the default queue pair assigned to the logical port that is specified by the received packet.

FIG. 3 depicts a block diagram of an example partition 150, according to an embodiment of the invention. The example partition 150 generically represents the partitions 150-1 and 150-2. The partition 150 includes an operating system 305, an allocation request 310, and an application 315.

The operating system 305 includes instructions capable of executing on the processor 101 or statements capable of being interpreted by instructions that execute on the processor 101. The operating system 305 controls the primary operations of the partition 150 in much the same manner as the operating system of a non-partitioned computer. The operating system 305 performs basic tasks for the partition 150, such as recognizing input from the keyboard of the terminal 121 and sending output to the display screen of the terminal 121. The operating system 305 may further open and close files or data objects, and read and write data to and from storage devices 125, 126, and 127, and control peripheral devices, such as disk drives and printers.

The operating system 305 may further support multi-user, multiple-processing, multi-tasking, and multi-threading operations. In multi-user operations, the operating system 305 may allow two or more users at different terminals 121 to run the applications 315 at the same time (concurrently). In multiprocessing operations, the operating system 305 may support running the applications 315 on more than one processor 101. In multi-tasking operations, the operating system 305 may support executing multiple applications 315 concurrently. In multithreading operations, the operating system 305 may support different parts or different instances of a single application 315 to run concurrently. In an embodiment, operating system 305 may be implemented using the i5/OS operating system available from International Business Machines Corporation, residing on top of a kernel. In various embodiments, the operating systems of different partitions may be the same or some or all of them may be different.

The applications 315 may be user applications, third party applications, or OEM (Original Equipment Manufacture) applications. In various embodiments, the applications 315 include instructions capable of executing on the processor 101 or statements capable of being interpreted by instructions that execute on the processor 101.

The allocation request 310 includes a tuple field 320, a queue pair identifier field 322, a priority field 324, a sub-priority field 326, and a requesting partition identifier field 328. The tuple field 320 identifies a packet or a set of packets for which the requesting partition 150 desires the processing performance of those packets to increase and requests that the hypervisor 152 increase the processing performance by allocating a resource in the network adapter 114 to the requesting partition 150 for the processing of those packet(s). The queue pair identifier field 322 identifies the queue pair that is allocated to the partition 150 that sends the allocation request 310.

The priority field 324 identifies the relative priority of the allocation request 310, as compared to other allocation requests that this partition or other partitions may send. If the priority field 324 specifies a high priority resource, then the hypervisor 152 must allocate the resource to the partition, even if the hypervisor 152 must preempt, deallocate, or take away the resource from another partition (whose allocation has a lower priority). The sub-priority field 326 identifies the relative sub-priority of the allocation request 310, as compared to other allocation requests that this partition may send that have the same priority 324. The contents of the sub-priority field 326 are used to determine resource allocation within a partition and allows a partition 150 to prioritize between its own allocations requests of the same priority level 324 within that same partition 150. Each partition independently decides what criteria to use to set this sub-priority 326. The requesting partition identifier field 328 identifies this partition 150 that sends the allocation request 310.

The operating system 305 or an application 315 of the partition 150 sends the allocation request 310 to the hypervisor 152, in response to determining that the packets identified by the tuple 320 need the speed of their processing increased, in order to provide better performance.

FIG. 4 depicts a block diagram of an example data structure for a configuration request 199, according to an embodiment of the invention. The configuration manager 198 sends the configuration requests 199 to the hypervisor 152, in order to control or limit the number of resources that the hypervisor 152 allocates to the partitions 150 in response to the allocation requests 310.

The configuration request 199 includes a partition identifier field 402, an upper limit of high priority resources field 404, an upper limit of medium priority resources field 406, and an upper limit of low priority resources field 408. The partition identifier field 402 identifies the partition 150 to which the limits 404, 406, and 408 of the configuration request 199 apply or are directed.

The upper limit of high priority resources field 404 specifies the upper limit or maximum number of resources that have a high relative priority (the highest priority) that the configuration manager 198 allows the hypervisor 152 to allocate to the partition 150 identified by the partition identifier field 402. A high priority resource is a resource that must be allocated to the partition if the partition requests allocation of the high priority resource via sending an allocation request 310 that specifies a priority 324 of high. In the example data shown in FIG. 4, the configuration request 199 specifies that the partition identified by the partition identifier 402 is only allowed to allocate, at a maximum, one high priority resource, as specified by the upper limit 404.

The upper limit of medium priority resources field 406 specifies the upper limit or maximum number of resources that have a medium relative priority that the configuration manager 198 allows the hypervisor 152 to allocate to the partition 150 identified by the partition identifier field 402. The medium priority is less than, or is less important, than the high priority. In the example data shown in FIG. 4, the configuration request 199 specifies that the partition identified by the partition identifier 402 is only allowed to allocate, at a maximum, five medium priority resources, as specified by the upper limit 406.

The upper limit of low priority resources field 408 specifies the upper limit or maximum number of resources that have a low relative priority that the configuration manager 198 allows the hypervisor 152 to allocate to the partition 150 identified by the partition identifier field 402. The low priority is the lowest priority and is lower than the medium priority, but in other embodiments any number of priorities with any appropriate definitions and relative importance may be used. In the example data shown in FIG. 4, the configuration request 199 specifies that the partition identified by the partition identifier 402 is only allowed to allocate, at a maximum, eight low priority resources, as specified by the upper limit 408.

FIG. 5 depicts a block diagram of an example data structure for resource limits 154, according to an embodiment of the invention. The hypervisor 152 adds data to the resource limits 154 from the configuration requests 199 (for a variety of partitions) that the hypervisor 152 receives from the configuration manager 198 if the configuration requests 199 meet a criteria, as further described below with reference to FIG. 7.

The resource limits 154 includes example records 505 and 510, each of which includes a partition identifier field 515, an associated upper limit on the number of high priority resources field 520, an associated upper limit on the number of medium priority resources field 525, and an associated upper limit on the number of low priority resources field 530. The partition identifier field 515 identifies the partition 150 associated with the respective record.

The upper limit on the number of high priority resources field 520 specifies the upper limit or maximum number of resources that have a high relative priority that the configuration manager 198 allows the hypervisor 152 to allocate to the partition 150 identified by the partition identifier field 515.

The upper limit on the number of medium priority resources field 525 specifies the upper limit or maximum number of resources that have a medium relative priority that the configuration manager 198 allows the hypervisor 152 to allocate to the partition 150 identified by the partition identifier field 515.

The upper limit on the number of low priority resources field 530 specifies the upper limit or maximum number of resources that have a low relative priority that the configuration manager 198 allows the hypervisor 152 to allocate to the partition 150 identified by the partition identifier field 515.

FIG. 6 depicts a block diagram of an example data structure for configuration data 156, according to an embodiment of the invention. The configuration data 156 includes allocated resources 602 and saved allocation requests 604. The allocated resources 602 represents the resources in the network adapter 114 that have been allocated to the partitions 150 or that are idle. The allocated resources 602 includes example records 606, 608, 610, 612, 614, 616, 618, and 620 each of which includes a resource identifier field 630, a partition identifier field 632, a priority field 634, and a sub-priority field 636.

The resource identifier field 630 identifies a resource in the network adapter 114. The partition identifier field 632 identifies a partition 150 to which the resource identified by the resource identifier field 630 is allocated, in response to an allocation request 310. That is, the partition 150 identified by the partition identifier field 632 owns and has exclusive use of the resource identified by the resource identifier field 630, and other partitions are not allowed to use or access that resource. The priority field 634 identifies the relative priority or importance of the allocation of the resource 630 to the requesting partition 632, as compared to all other allocations of other resources to the same or different partitions. The priority field 634 is set from the priority 324 of the allocation request 310 that requested allocation of the resource 630. The sub-priority field 636 indicates the relative priority or importance of the allocation of the resource 630 to the requesting partition 632, as compared to all other allocations of other resources to the same partition 632. The contents of the sub-priority field 636 are set from the sub-priority 326 of the allocation request 310 that requested its allocation. The contents of the sub-priority field 636 are used to determine resource allocation within a single partition 632 and allows the partition 632 to prioritize between requests of the same priority level 634 within that same partition 632. Each partition independently decides what criteria to use to set this sub-priority 636.

The saved allocation requests 604 includes example records 650 and 652, each of which includes a tuple field 660, a queue pair identifier 662, a priority field 664, a sub-priority field 666, and a requesting partition identifier field 668. Each of the records 650 and 652 represents an allocation request that the hypervisor 152 temporarily could not fulfill or represents an allocation that was preempted by another, higher priority allocation request. Thus, the saved allocation requests 604 represent requests for allocation that are not currently fulfilled.

The tuple field 660 identifies a packet or a set of packets for which the requesting partition 668 desires the processing performance of those packets to increase and requests that the hypervisor 152 increase the processing performance by allocating a resource in the network adapter 114 to the partition 668 for the processing of the packet. The queue pair identifier field 662 identifies the queue pair that is requested to be allocated to the partition 668 that sends the allocation request 310.

The priority field 664 identifies the relative priority of the allocation request of the record, as compared to other allocation requests that this or other partitions may send. The sub-priority field 666 identifies the relative sub-priority of the allocation request, as compared to other allocation requests that this requesting partition 668 may send. The contents of the sub-priority field 666 are used to determine resource allocation within a partition and allows a partition to prioritize between requests of the same priority level 664 within that same partition. Each partition independently decides what criteria to use to set this sub-priority 666. The requesting partition identifier field 668 identifies the partition 150 that sent the allocation request.

FIG. 7 depicts a flowchart of example processing for configuration and activation requests, according to an embodiment of the invention. Control begins at block 700. Control then continues to block 705 where the configuration manager 198 sends a configuration request 199 to the computer system 100, and the hypervisor 152 receives the configuration request 199. The configuration manager 198 may send the configuration request 199 in response to a user interface selection via the I/O device 192 or based on a programmatic criteria. In response to receiving the configuration request 199, the hypervisor 152 reads the records 606, 608, 610, 612, 614, 616, 618, and 620 from the allocated resources 602 of the configuration data 156.

In an embodiment, the hypervisor 152 receives the configuration request 199 while the partition 150 identified by the partition identifier field 402 is inactive. If the hypervisor 152 receives the configuration request 199 while the partition is active, the hypervisor 152 either rejects the configuration request 199 or does not apply the changes of the configuration request 199 to the resource limits 154 until the next time that the partition is inactive. But, in another embodiment the hypervisor 152 may receive and apply configuration requests 199 dynamically at any time.

Control then continues to block 710 where the configuration manager 198 sends an activation request to the hypervisor 152 of the computer system 100. The configuration manager 198 may send the activation request in response to a user interface selection via the I/O device 192 or in response to a programmatic criteria being met. The activation request specifies a partition to be activated. The hypervisor 152 receives the activation request from the configuration manager 198, and in response, the hypervisor 152 activates the partition 150 specified by the activation request. Activating the partition includes allocating memory and one or more processors to the specified partition 150, starting the operating system 305 executing on at least one of the processors 101, allocating a queue pair to the partition 150, and optionally starting one more applications 315 of the partition 150 executing on at least one of the processors 101. The hypervisor 152 notifies the partition of an identifier of its allocated queue pair.

Control then continues to block 715 where (in response to receiving the configuration request 199 and/or in response to receiving the activation request) the hypervisor 152 determines whether the upper limits of the high priority resources 404 in the configuration request 199 plus the sum of all the upper limits of high priority resources 520 in the resource limits 154 for all partitions is less than or equal to the total number of resources (the total or maximum number of records) in the resource data 215. The total or maximum number of records in the resource data 215 represents the total or maximum number of allocable resources in the network adapter 114.

If the determination at block 715 is true, then the upper limit of the high priority resources 404 in the configuration request 199 plus the sum of all the upper limit of high priority resources 520 in the resource limits 154 for all partitions is less than or equal to the total number of resources in the resource data 215 (the total number of allocable resources in the network adapter 114), so control continues to block 720 where the hypervisor 152 adds a record to the resource limits 154 with data from the configuration request 199. That is, the hypervisor 152 copies the partition identifier 402 from the configuration request 199 to the partition identifier 515 in the new record in the resource limits 154, copies the upper limit of high priority resources 404 from the configuration request 199 to the upper limit of high priority resources 520 in the new record in the resource limits 154, copies the upper limit of medium priority resources 406 from the configuration request 199 to the upper limit of medium priority resources 525 in the new record in the resource limits 154, and copies the upper limit of low priority resources 408 from the configuration request 199 to the upper limit of low priority resources 530 in the new record in the resource limits 154.

Control then continues to block 799 where the logic of FIG. 7 returns.

If the determination at block 715 is false, then the upper limit of the high priority resources 404 plus the sum of all the upper limit of high priority resources 520 is greater than the total number of resources (the number of records) in the resource data 215, so control continues to block 730 where the hypervisor 152 returns an error to the configuration manager 198 because the network adapter 114 does not have enough resources to satisfy the high priority configuration request. The error notification of block 730 indicates a failure of the partition activation, not a failure of the setting of the configuration data 156. Stated another way, the resource limits 154 reflect all currently active and running partitions, and a partition is only allowed to start (is only activated) if its configuration request 199 fits within the remaining available resource limits. Control then continues to block 799 where the logic of FIG. 7 returns.

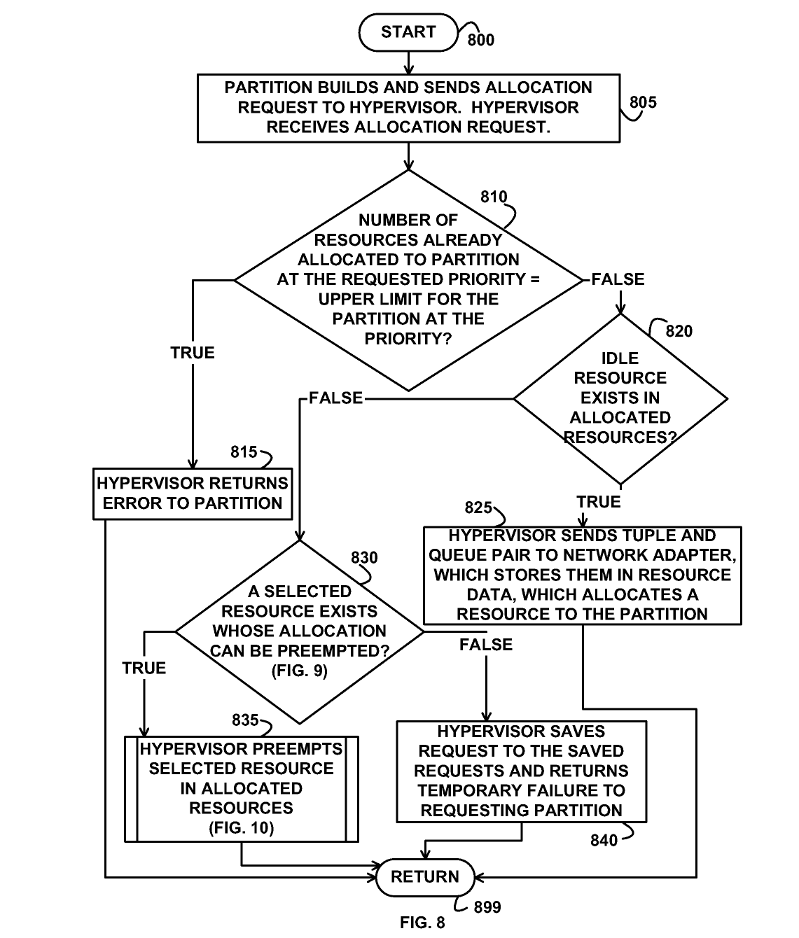

FIG. 8 depicts a flowchart of example processing for an allocation request, according to an embodiment of the invention. Control begins at block 800. Control then continues to block 805 where a requesting partition 150 (an operating system 305 or application 315 within the requesting partition 150) builds and sends an allocation request 310 to the hypervisor 152. The requesting partition 150 builds and sends the allocation request 310 in response to determining that the processing for a packet or a set of packets needs a performance acceleration or increase. The allocation request 310 identifies the queue pair 322 that was allocated to the partition (previously allocated by the hypervisor 152 at block 710), the tuple 320 that identifies the packets that the partition desires to accelerate, the priority 324 of the resource that the partition desires to allocate, the sub-priority 326 of the resource that the partition 150 assigns as compared to other resources allocated to this partition 150, and a partition identifier 328 of the requesting partition 150. The hypervisor 152 receives the allocation request 310 from the requesting partition 150 identified by the requesting partition identifier field 328.

Control then continues to block 810 where, in response to receiving the allocation request 310, the hypervisor 152 determines whether the number of resources that are already allocated (to the partition 328 that sent the allocation request 310) at the requested priority 324 is equal to the upper limit (520, 525, or 530 corresponding to the priority 324) for the partition 328 at the priority 324. The hypervisor 152 makes the determination of block 810 by counting (determining the number of) all records in the allocated resources 602 with a partition identifier 632 that matches the partition identifier 328 and with a priority 634 that matches the priority 324. The hypervisor 152 then finds the record in the resource limits 154 with a partition identifier 515 that matches the partition identifier 328.

The hypervisor 152 then selects the field (520, 525, or 530) in the found record of the resource limits 154 that is associated with the priority 324. For example, if the priority 324 is high, then the hypervisor 152 selects the upper limit of the high priority field 520 in the found record; if the priority 324 is medium, then the hypervisor 152 selects the upper limit of medium priority resources field 525 in the found record; and if the priority 324 is low, then the hypervisor 152 selects the upper limit of the low priority resources field 530 in the found record. The hypervisor 152 then compares the value in the selected field (520, 525, or 530) in the found record in the resource limits 154 to the count of the number of records in the allocated resources 602. If they are the same, then the determination of block 810 is true; otherwise, the determination is false.

If the determination at block 810 is true, then the number of resources that are already allocated (to the partition 328 that sent the allocation request 310) at the requested priority 324 is equal to the upper limit (520, 525, or 530) for the partition 328 at the priority 324, so control continues to block 815 where the hypervisor 152 returns an error to the partition that sent the allocation request 310 because the partition has already been allocated its limit of resources at that priority level 324. Control then continues to block 899 where the logic of FIG. 8 returns.

If the determination at block 810 is false, then the number of resources that are already allocated (to the partition 328 that sent the allocation request 310) at the requested priority 324 is not equal to the upper limit (520, 525, or 530 depending on the priority 324) for the partition 328 at the priority 324, so a request for allocation of additional resources by the requesting partition 150 will be considered by the hypervisor 152, so control continues to block 820 where the hypervisor 152 determines whether an idle resource (a resource that is not already allocated to any partition) exists in the allocated resources 602. The hypervisor 152 makes the determination of block 820 by searching the allocated resources 602 for a record that is not allocated to any partition, e.g., by searching for a record whose partition identifier 632 indicates that the respective resource 630 is not allocated to any partition, or is idle. In the example of FIG. 6, the records 616, 618, and 620 indicate that their respective resources 630 of “resource F,” “resource G,” and “resource H” are idle, meaning that they are not allocated to any partition.

If the determination at block 820 is true, then an idle resource exists in the network adapter 114, so control continues to block 825 where the hypervisor 152 sends the identifiers of the tuple 320 and the queue pair 322 that were received in the allocation request 310 and the identifier of the found idle resource 630 to the network adapter 114. The logic 220 of the network adapter 114 receives the tuple 320 and the queue pair identifier 322 and stores them in the tuple 240 and the destination queue pair identifier 242, respectively, in a record in the resource data 215. The logic 220 of the network adapter 114 further creates a resource identifier for the record that matches the identifier of the found idle resource 630 and stores the resource identifier 238 in the record. By storing the resource identifier 238, the tuple 240, and the queue pair identifier 242 in a record in the resource data 215, the network adapter 114 allocates the resource represented by the record to the partition (the requesting partition) that owns the queue pair identified by the queue pair identifier 242. Thus, a mapping of the tuple to the queue pair is stored into the selected resource. The hypervisor 152 sets the partition identifier field 632 in the allocated resources 602 to indicate that the resource is no longer idle and is now allocated to the requesting partition. Control then continues to block 899 where the logic of FIG. 8 returns.

If the determination at block 820 is false, then an idle resource does not exist in the network adapter 114 and all resources in the network adapter 114 are currently allocated to partitions, so control continues to block 830 where the hypervisor 152 determines whether a selected resource exists whose allocation (to this or another partition) can be preempted (changed), as further described below with reference to FIG. 9.

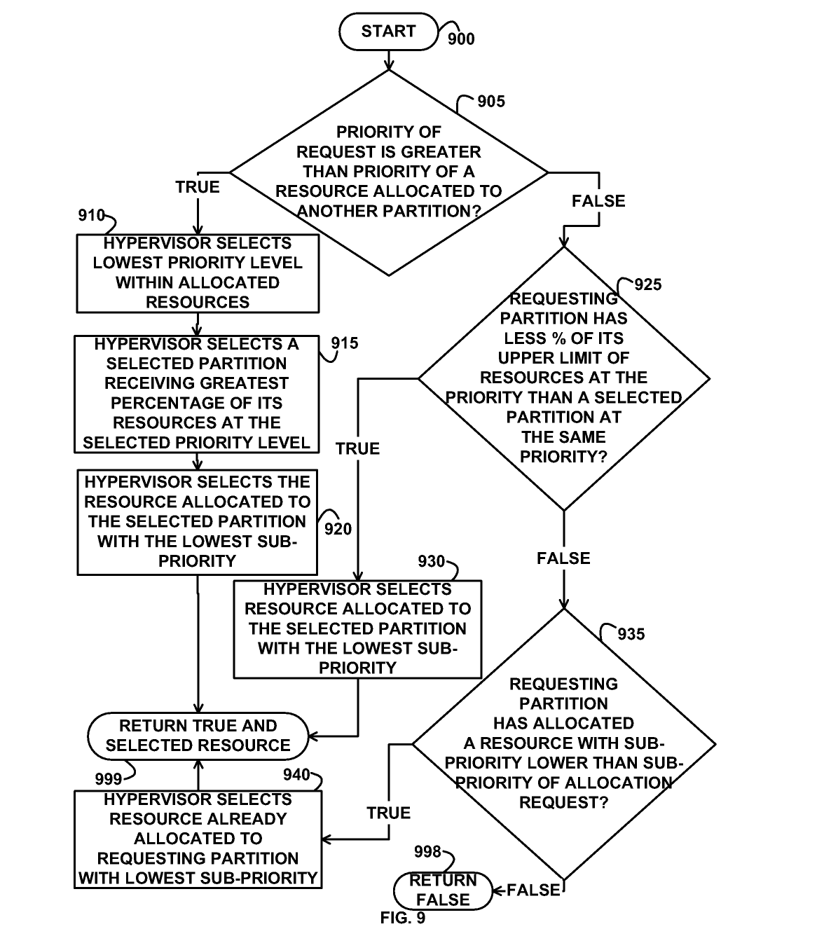

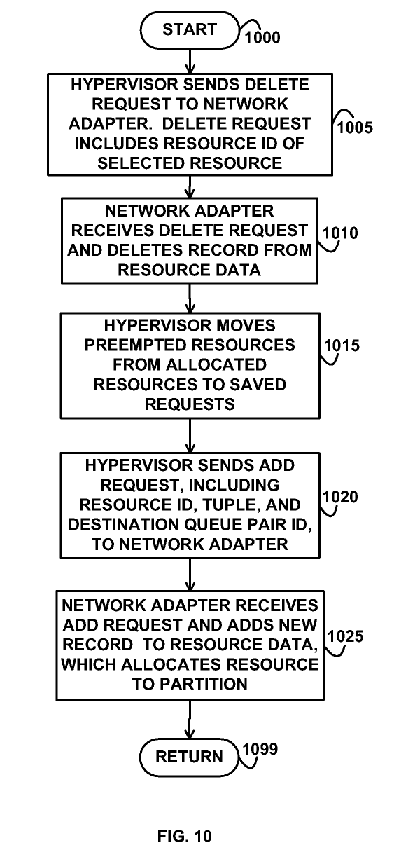

If the determination at block 830 is true, then a selected resource exists whose allocation can be preempted, so control continues to block 835 where the hypervisor 152 preempts the allocation of a selected resource and allocates the selected resource to the requesting partition, as further described below with reference to FIG. 10. Control then continues to block 899 where the logic of FIG. 8 returns.

If the determination at block 830 is false, then a selected resource does not exist whose allocation can be preempted, so control continues to block 840 where the hypervisor 152 saves the request 310 to the saved requests 604 without allocating any resource to the requesting partition and returns a temporary failure to the partition 150 identified by the requesting partition identifier 328. Control then continues to block 899 where the logic of FIG. 8 returns.

FIG. 9 depicts a flowchart of example processing for determining whether an allocated resource should be preempted, according to an embodiment of the invention. Control begins at block 900. Control then continues to block 905 where the hypervisor 152 determines whether the priority 324 of the allocation request 310 is greater (more important) than the priority 634 of a resource (the priority of the request that caused the resource to previously be allocated) allocated to another partition (different from the requesting partition 328). If the determination at block 905 is true, then the priority 324 of the current allocation request is greater (higher or more important) than the priority 634 of the previous allocation request that caused the resource to be allocated to another partition (as indicated by a record in the allocated resources 602 where the partition identifier 632 is different than the requesting partition identifier 328), so control continues to block 910 where the hypervisor 152 selects the lowest priority level 634 of all the priorities in all of the records within the allocated resources 602. Using the example of FIG. 6, the lowest priority in the allocated resources 602 is the medium priority level, as indicated in records 612 and 614, which is lower than the high priority level of records 606, 608, and 610.

Control then continues to block 915 where the hypervisor 152 selects the partition 632 that receives the greatest percentage of its allocated resources 630 at the selected priority level. Using the example data of FIG. 6, the partition B receives 50% of its allocated resources at the medium priority level because the partition B has one allocated resource at the medium priority level (as indicated in the record 614) and one allocated resource at the high priority level (as indicated in the record 610). In contrast, the partition A receives 33% of its total allocated resources (across all priority levels) at the medium priority level because the partition A has one allocated resource at the medium priority level (as indicated in the record 612) and two allocated resources at the high priority level (records 606 and 608). Thus, the partition B receives the greatest percentage of its total allocated resources at the medium priority level because 50% is greater than 33%.

Referring again to FIG. 9, control then continues to block 920 where the hypervisor 152 selects the resource 630 that is allocated to the selected partition 632 with the lowest sub-priority 636, as compared to other resources that are allocated to the selected partition. Control then continues to block 999 where the logic of FIG. 9 returns true and returns the selected resource to the invoker of the logic of FIG. 9.

If the determination at block 905 is false, then the priority 324 of the allocation request 310 is not greater (not higher or more important) than the priority 634 of a resource allocated to another partition (as indicated by a record in the allocated resources 602 where the partition identifier 632 is different than the requesting partition identifier 328), and the priority of the allocation request is less than or equal to the priority of all resources currently allocated, so control then continues to block 925 where the hypervisor 152 determines whether the requesting partition 328 has a smaller percentage of its upper limit (525 or 530) of allocated resources at the priority 324 than the percentage of the upper limit (525 or 530) of resources allocated to a selected partition at the priority 634, where the priorities 634 and 324 are identical, equal, or the same.

If the determination at block 925 is true, then the requesting partition 328 has a smaller percentage of its upper limit (525 or 530) of allocated resources at the priority 324 than the percentage of the upper limit (525 or 530) of resources allocated to a selected partition at the same priority 634 (the same priority as the priority 324), so control continues to block 930 where the hypervisor 152 selects the resource allocated to the selected partition with the lowest sub-priority 636. Control then continues to block 999 where the logic of FIG. 9 returns true and the selected resource to the invoker of the logic of FIG. 9.

If the determination at block 925 is false, then the requesting partition 328 has a percentage of its upper limit (525 or 530) of allocated resources at the priority 324 that is greater than or equal to the percentage of the upper limit (525 or 530) of resources that are allocated to all other partitions at the same priority 634 (the same priority as the priority 324), so control continues to block 935 where the hypervisor 152 determines whether the requesting partition 328 has previously allocated a resource in the allocated resources 602 with a sub-priority 636 that is lower than the sub-priority 326 of the allocation request 310.

If the determination at block 935 is true, then the requesting partition 328 previously allocated a resource in the allocated resources 602 with a sub-priority 636 that is lower than the sub-priority 326 of the allocation request 310, so control continues to block 940 where the hypervisor 152 selects the resource that is already allocated (was previously allocated via a previous allocation request) to the requesting partition 328 that sent the request with the lowest sub-priority 636. Control then continues to block 999 where the logic of FIG. 9 returns true and returns the selected resource to the invoker of the logic of FIG. 9, where the invoker is the logic of FIG. 8.

If the determination at block 935 is false, then the requesting partition 328 has not previously allocated a resource in the allocated resources 602 with a sub-priority 636 that is lower than the sub-priority 326 of the allocation request 310, so control continues to block 998 where the logic of FIG. 9 returns false (indicating that a previously allocated resource is not allowed to be preempted) to the invoker of FIG. 9, where the invoker is the logic of FIG. 8.

FIG. 10 depicts a flowchart of example processing for preempting the allocation of a resource, according to an embodiment of the invention. In an embodiment, preemption of a previously allocated resource includes changing the mapping that a record (resource) in the resource data 215 provides from a first mapping (first association) of a first tuple and a first destination queue pair to a second mapping (second association) of a second tuple and a second destination queue pair. In various embodiments, the first destination queue pair and the second destination queue pair may be the same or different queue pairs.

Control begins at block 1000. Control then continues to block 1005 where the hypervisor 152 sends a delete request to the network adapter 114. The delete request includes a resource identifier of the selected resource, which is the preempted resource. The selected resource was selected as previously described above with respect to block 830 of FIG. 8 and with respect to the logic of FIG. 9.

Control then continues to block 1010 where the network adapter 114 receives the delete request from the hypervisor 152 and deletes the record (or deletes the data in the tuple 240 and the destination queue pair identifier 242 from the record) from the resource data 215 that is identified by the received resource identifier (whose resource identifier 238 matches the resource identifier of the delete request). Control then continues to block 1015 where the hypervisor 152 moves the preempted resource record (the record whose resource identifier 630 matches the resource identifier of the delete request) from the allocated resources 602 to the saved requests 604, which deallocates the selected resource.

Control then continues to block 1020 where the hypervisor 152 sends an add request including the resource identifier of the preempted resource, the tuple 320 specified in the allocation request 310, and the destination queue pair identifier 322 specified in the allocation request 310, to the network adapter 114. Control then continues to block 1025 where the network adapter 114 receives the add request and adds or stores a new record to the resource data 215, which stores the resource identifier of the preempted resource to the resource identifier 238, stores the tuple 320 specified in the allocation request 310 to the tuple 240, and stores the destination queue pair identifier 322 specified in the allocation request 310 to the destination queue pair identifier 242, which acts to allocate the resource (the record) identified by the resource identifier 238 to the requesting partition that owns the destination queue pair identified by the destination queue pair identifier 242. Thus, a mapping of the tuple to the queue pair is stored into the selected resource. Control then continues to block 1099 where the logic of FIG. 10 returns.

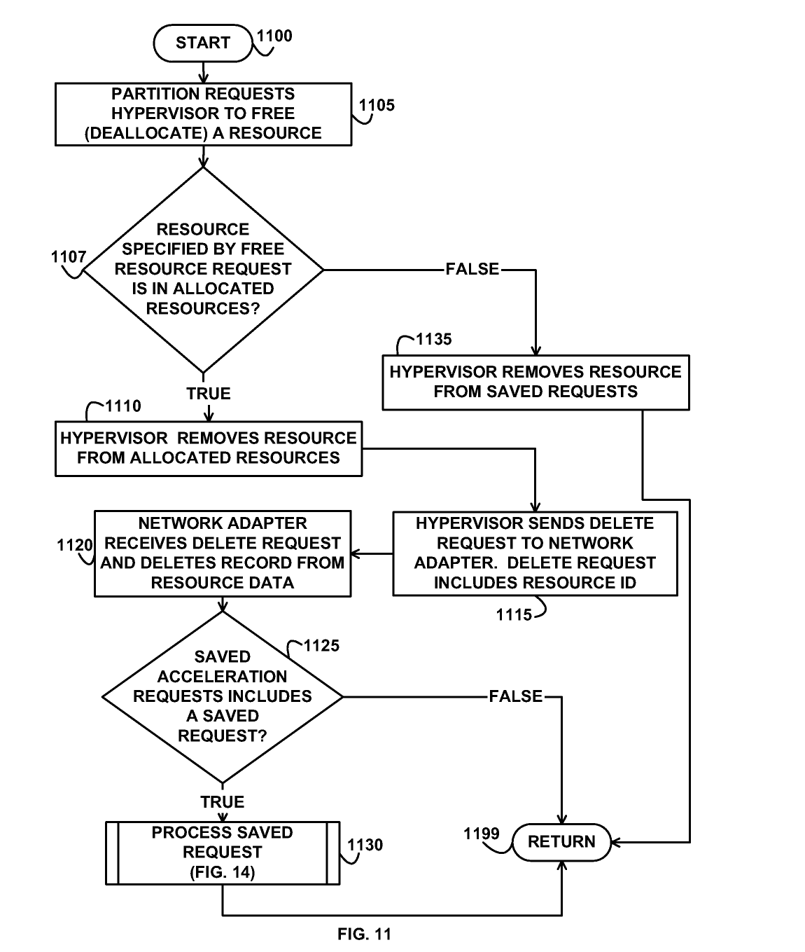

FIG. 11 depicts a flowchart of example processing for deallocating a resource, according to an embodiment of the invention. Control begins at block 1100. Control then continues to block 1105 where the partition 150 requests the hypervisor 152 to free or deallocate a resource (that was previously requested to be allocated to the partition) because the partition no longer has a need for accelerated performance of packets using the resource. The request include a resource identifier of the resource, a tuple, and/or an identifier of the requesting partition. Control then continues to block 1107 where the hypervisor 152 determines whether the resource specified by the free resource request is specified in the allocated resources 602.

If the determination at block 1107 is true, then the resource specified by the free resource request is in the allocated resources 602, meaning that the resource is allocated, so control continues to block 1110 where the hypervisor 152 removes the record with a resource identifier 630 that matches the requested resource identifier of the deallocate request from the allocated resources 602 or sets the partition identifier 632 in the record to indicate that the resource identified by the resource identifier 630 is free, idle, deallocated, or not currently allocated to any partition. Control then continues to block 1115 where the hypervisor 152 sends a delete request to the network adapter 114. The delete request specifies the resource identifier that was specified in the deallocate request. Control then continues to block 1120 where the network adapter 114 receives the delete request and deletes the record from the resource data 215 that includes a resource identifier 238 that matches the resource identifier specified by the delete request. The resource is now deallocated.

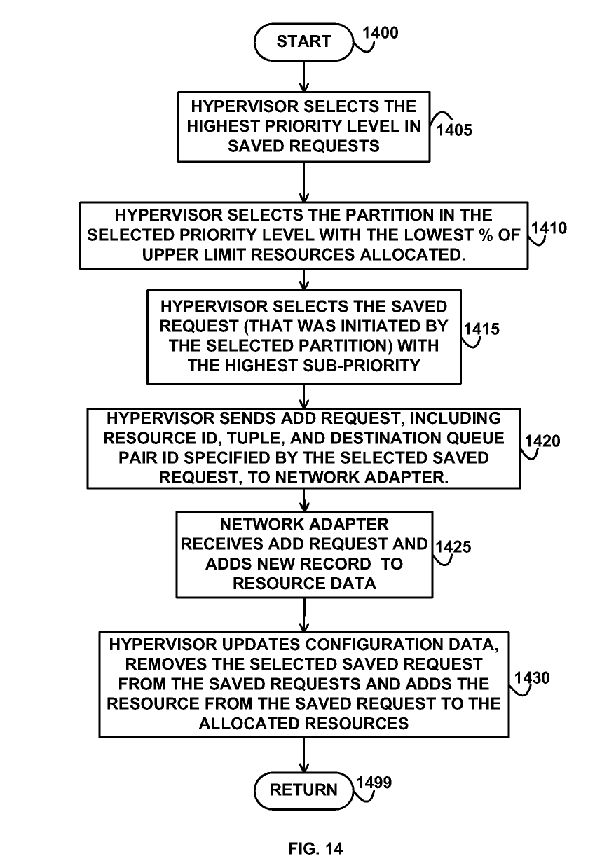

Control then continues to block 1125 where the hypervisor 152 determines whether the saved allocation requests 604 includes at least one saved request. If the determination at block 1125 is true, then the saved allocation requests 604 includes a saved request that desires allocation of a resource, so control continues to block 1130 where the hypervisor 152 finds a saved request and allocates a resource for it, as further described below with reference to FIG. 14. Control then continues to block 1199 where the logic of FIG. 11 returns.

If the determination at block 1125 is false, then the saved allocation requests 604 do not include a saved request, so control continues to block 1199 where the logic of FIG. 11 returns.

If the determination at block 1107 is false, then the resource specified by the free (deallocate) resource request is not in the allocated resources 602, so control continues to block 1135 where the hypervisor 152 finds a record in the saved requests 604 with a tuple 660 and a partition identifier 668 that match the tuple and requesting partition identifier specified by the deallocate request and removes the found record from the saved requests 604. Control then continues to block 1199 where the logic of FIG. 11 returns.

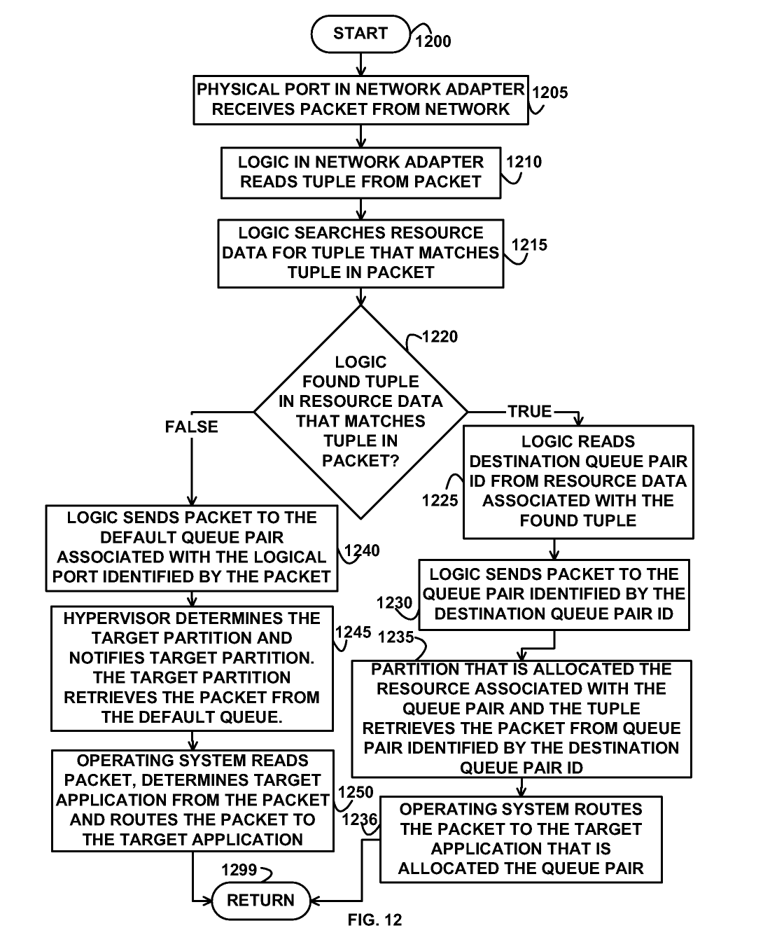

FIG. 12 depicts a flowchart of example processing for receiving a packet from the network, according to an embodiment of the invention. Control begins at block 1200. Control then continues to block 1205 where the physical port 225 in the network adapter 114 receives a packet of data from the network 130. The received packet of data includes a physical port address that matches the network address of the physical port 225.

Control then continues to block 1210 where the logic 220 in the network adapter 114 reads a tuple from the received packet or creates a tuple from a combination of data in the received packet. Control then continues to block 1215 where the logic 220 searches the resource data 215 for a tuple 240 that matches the tuple that is in the packet or that was created from the packet. Control then continues to block 1220 where the logic 220 determines whether a tuple 240 in the resource data 215 was found that matches the tuple that is in the packet or that was created from the packet.

If the determination at block 1220 is true, then the logic 220 found a record (resource) in the resource data 215 with a tuple 240 that matches the tuple in the packet, meaning that a resource is allocated for the packet's tuple, so control continues to block 1225 where the logic 220 reads the destination queue pair identifier 242 from the resource data record associated with the found tuple 240. Control then continues to block 1230 where the logic 220 sends the packet to the queue pair (stores the packet in the queue pair) identified by the destination queue pair identifier 242 in the found record (resource).

Control then continues to block 1235 where the partition 632 that is allocated the resource (the partition 632 in the record of the allocated resources 602 with a resource identifier 630 that matches the resource identifier 238 for the received tuple 240) retrieves the packet from the queue pair identified by the destination queue pair identifier 242. Control then continues to block 1236 where the operating system 305 (or other code) in the partition 150 identified by the partition identifier 632 routes the packet to the target application 315 and/or session of the target application 315 that is allocated the queue pair, which is identified by the destination queue pair identifier 242. Control then continues to block 1299 where the logic of FIG. 12 returns.

If the determination at block 1220 is false, then the logic 220 did not find a tuple 240 in the resource data 215 that matches the tuple in (or created from) the received packet, so the tuple of the received packet has not been allocated a resource, so control continues to block 1240 where the logic 220 sends (stores) the received packet to the default queue pair associated with, or assigned to, the logical port specified by the received packet.

Control then continues to block 1245 where the hypervisor 152 determines the partition that is the target destination of the packet and notifies the partition. In response to the notification, the partition (the operating system 305) retrieves the packet from the default queue. Control then continues to block 1250 where the operating system 305 (or other code) in the partition 150 identified by the partition identifier 632 reads the packet, determines the target application 315 and/or session of the target application 315 from the data in the packet, and routes the packet to the determined target application. In an embodiment, the operating system 305 reads the TCP/IP stack of the packet, in order to determine the target application. Control then continues to block 1299 where the logic of FIG. 12 returns.

In an embodiment, the processing of block 1250 is slower than the processing of block 1236 because of the need of the processing of block 1250 to determine the target application and/or session by interrogating the data in the received packet, so an embodiment of the invention (illustrated by the processing of blocks 1225, 1230, 1235, and 1236) provides better performance by taking advantage of the selective allocation of the resources to the mapping of the tuples 240 to the destination queue pair identifiers 242.

FIG. 13 depicts a flowchart of example processing for deactivating a partition, according to an embodiment of the invention. Control begins at block 1300. Control then continues to block 1305 where the hypervisor 152 receives a deactivation request from the configuration manager 198 and, in response, de-activates the partition 150. The hypervisor 152 may deactivate the partition 150, e.g., by stopping execution of the operating system 305 and the application 315 on the processor 101 and by deallocating resources that were allocated to the partition 150.

Control continues to block 1307 where the hypervisor 152 changes all resources allocated to the deactivated partition in the allocated resources 602 to indicate that the resource is idle, free, or deallocated by, e.g., changing the partition identifier field 632 for the records that specified the deactivated partition to indicate that the resource identified by the corresponding resource field 630 is idle or not currently allocated to any partition. Control then continues to block 1310 where the hypervisor 152 removes all resource requests for the deactivated partition from the saved requests 604. For example, the hypervisor 152 finds all records in the saved allocations 604 that specify the deactivated partition in the requesting partition identifier field 668 and removes those found records from the saved allocation requests 604.

Control then continues to block 1315 where the hypervisor 152 removes all limits for the deactivated partition from the resource limits 154. For example, the hypervisor 152 finds all records in the resource limits 154 that specify the deactivated partition in the partition identifier field 515 and removes those found records from the resource limits 154.

Control then continues to block 1317 where the hypervisor 152 sends a delete request to the network adapter 114 that specifies all of the resources that allocated to the deactivated partition. Control then continues to block 1320 where the network adapter 114 receives the delete request and deletes the record(s) from the resource data 215 whose resource identifier 238 matches the resource identifier 630 in records of the allocated resources 602 with a partition identifier 632 that matches the deactivated partition. Control then continues to block 1325 where the hypervisor 152 determines whether the allocated resources 602 has an idle resource and the saved allocation requests 604 includes at least one saved request (has at least one record).

If the determination at block 1325 is true, then the allocated resources 602 has an idle resource and the saved allocation requests 604 includes at least one saved request, so control continues to block 1330 where the hypervisor 152 processes the saved request by finding a saved request and allocating a resource for it, as further described below with reference to FIG. 14. Control then returns to block 1325, as previously described above.

If the determination at block 1325 is false, then the allocated resources 602 does not have an idle resource or the saved allocation requests 604 does not include a saved request, so control continues to block 1399 where the logic of FIG. 13 returns.

FIG. 14 depicts a flowchart of example processing for handling a saved allocation request, according to an embodiment of the invention. Control begins at block 1400. Control then continues to block 1405 where the hypervisor 152 selects the highest priority level 664 in the saved requests 604. (In the example of FIG. 6, the highest priority level of all requests in the saved allocation requests 604 is “medium,” as indicated in record 650, which is higher than the “low” priority of the record 652.)

Control then continues to block 1410 where the hypervisor 152 selects the partition 668 that has the lowest percentage of its upper limit (520, 525, or 530, depending on the selected priority level) of resources allocated at the selected highest priority level. (In the example of FIGS. 5 and 6, both partition A and partition B have one resource allocated at the medium priority level, as indicated in records 612 and 614, and partition A's upper limit of medium priority resources 525 is “5,” as indicated in record 505, while partition B's upper limit of medium priority resources 525 is “2,” as indicated in record 510. Thus, partition A's percentage of its upper limit of medium priority resources that are allocated is 20% (⅕*100) while partition B's percentage of its upper limit of medium priority resources that are allocated is 50% (½*100), so partition A has the lowest percentage of its upper limit of resources that allocated by medium priority requests since 20%<50%.

Control then continues to block 1415 where the hypervisor 152 selects the saved request (that was initiated by the selected partition 668) with the highest sub-priority 666. Control then continues to block 1420 where the hypervisor 152 sends an add request, including a resource identifier of the idle resource, the tuple 660 of the selected saved request, and the destination queue pair identifier 662 of the selected saved request to the network adapter 114.

Control then continues to block 1425 where the network adapter 114 receives the add request and adds a new record to the resource data 215, including the resource identifier 238, tuple 240, and destination queue pair identifier 242 that were specified in the add request. Control then continues to block 1430 where the hypervisor 152 updates the configuration data 156 by removing the selected saved request from the saved requests 604 and by adding the resource from the saved request to the allocated resources 602, including the resource identifier, the partition identifier, the priority, and the sub-priority. Control then continues to block 1499 where the logic of FIG. 14 returns.

In the previous detailed description of exemplary embodiments of the invention, reference was made to the accompanying drawings (where like numbers represent like elements), which form a part hereof, and in which is shown by way of illustration specific exemplary embodiments in which the invention may be practiced. These embodiments were described in sufficient detail to enable those skilled in the art to practice the invention, but other embodiments may be utilized and logical, mechanical, electrical, and other changes may be made without departing from the scope of the present invention. In the previous description, numerous specific details were set forth to provide a thorough understanding of embodiments of the invention. But, the invention may be practiced without these specific details. In other instances, well-known circuits, structures, and techniques have not been shown in detail in order not to obscure the invention.

Different instances of the word “embodiment” as used within this specification do not necessarily refer to the same embodiment, but they may. Any data and data structures illustrated or described herein are examples only, and in other embodiments, different amounts of data, types of data, fields, numbers and types of fields, field names, numbers and types of rows, records, entries, or organizations of data may be used. In addition, any data may be combined with logic, so that a separate data structure is not necessary. The previous detailed description is, therefore, not to be taken in a limiting sense, and the scope of the present invention is defined only by the appended claims.

What is claimed is:

1. A method comprising:
receiving a first allocation request from a first requesting partition, wherein the first allocation request comprises a tuple and an identifier of a queue;
selecting a selected resource from among a plurality of resources, wherein the selected resource is allocated to a selected partition; and
allocating the selected resource to the first requesting partition, wherein the allocating further comprises storing a mapping of the tuple to the queue into the selected resource.

2. The method of claim 1, wherein the first allocation request further comprises a first priority, wherein the selected partition sent a second allocation request comprising a second priority, and wherein the selecting further comprises:
determining that the first priority is greater than the second priority; and
determining that the selected partition is allocated a greatest percentage of its allocated resources at the second priority, as compared to percentages of the resources allocated at the second priority to other of a plurality of partitions.

3. The method of claim 2, wherein the selecting further comprises:
selecting the second priority to be a lowest priority that is assigned to the plurality of resources.

4. The method of claim 3, wherein the selecting further comprises:
selecting the selected resource with a lowest sub-priority of the resources that are allocated to the selected partition.

5. The method of claim 1, wherein the first allocation request further comprises a first priority, wherein the selected partition sent a second allocation request comprising a second priority, and wherein the selecting further comprises:
determining that the first priority is less than or equal to priorities of all of the plurality of resources that are currently allocated; and
determining that the first requesting partition has a less percentage of its upper limit of a number of the plurality of resources at the first priority than does the selected partition at the second priority, wherein the first priority and the second priority are equal.

6. The method of claim 5, wherein the selecting further comprises:
selecting the selected resource with a lowest sub-priority that is assigned to the resources that are allocated to the selected partition.

7. The method of claim 1, wherein the first allocation request further comprises a first priority, and wherein the selecting further comprises:
determining that the first priority is less than or equal to priorities of all of the plurality of resources that are currently allocated;
determining that the first requesting partition has a greater percentage of its upper limit of a number of the plurality of resources allocated at the first priority than do all other partitions of their upper limits at the first priority; and
selecting the selected resource that has a lowest sub-priority, as compared to the resources that are already allocated to the first requesting partition.

8. The method of claim 1, further comprising:
receiving a packet from a network;
determining that data in the packet matches the tuple; and
storing the packet in the queue specified by the mapping.

9. The method of claim 1, further comprising:
receiving a deallocation request from the first requesting partition;
selecting a first saved request from among a plurality of saved requests, wherein the first saved request was previously received from a second requesting partition and saved at a time when all of the plurality of resources were allocated and could not be preempted; and
allocating the selected resource to the second requesting partition.

10. The method of claim 9, wherein the selecting the first saved request further comprises:
selecting a highest priority of the plurality of saved requests;
selecting a second selected partition that has a lowest percentage of its upper limit of the plurality of resources allocated at the highest priority; and
selecting the first saved request that was sent by the second selected partition that has a highest sub-priority.

11. The method of claim 1, further comprising:
setting an upper limit of a number of the plurality of resources that the requesting partition is allowed to allocate at a first priority.

12. A storage medium encoded with instructions, wherein the instructions when executed comprise:
receiving a first allocation request from a first requesting partition, wherein the first allocation request comprises a tuple and an identifier of a queue;
deciding that all of a plurality of resources are allocated;
in response to the deciding, selecting a selected resource from among the plurality of resources, wherein the selected resource is allocated to a selected partition; and
allocating the selected resource to the first requesting partition, wherein the allocating further comprises storing a mapping of the tuple to the queue into the selected resource.

13. The storage medium of claim 12, wherein the first allocation request further comprises a first priority, wherein the selected partition sent a second allocation request comprising a second priority, and wherein the selecting further comprises:
determining that the first priority is greater than the second priority; and
determining that the selected partition is allocated a greatest percentage of its allocated resources at the second priority, as compared to percentages of the resources allocated at the second priority to other of a plurality of partitions.

14. The storage medium of claim 13, wherein the selecting further comprises:
selecting the second priority to be a lowest priority of the plurality of resources.

15. The storage medium of claim 14, wherein the selecting further comprises:
selecting the selected resource with a lowest sub-priority of the resources that are allocated to the selected partition.

16. The storage medium of claim 12, wherein the first allocation request further comprises a first priority, wherein the selected partition sent a second allocation request comprising a second priority, and wherein the selecting further comprises:
determining that the first priority is less than or equal to priorities of all of the plurality of resources that are currently allocated; and
determining that the first requesting partition has a less percentage of its upper limit of a number of the plurality of resources at the first priority than does the selected partition at the second priority, wherein the first priority and the second priority are equal.

17. The storage medium of claim 16, wherein the selecting further comprises:
selecting the selected resource with a lowest sub-priority that is assigned to the resources that are allocated to the selected partition.

18. The storage medium of claim 12, wherein the first allocation request further comprises a first priority, and wherein the selecting further comprises:
determining that the first priority is less than or equal to priorities of all of the plurality of resources that are currently allocated;
determining that the first requesting partition has a greater percentage of its upper limit of a number of the plurality of resources allocated at the first priority than do all other partitions of their upper limits at the first priority; and
selecting the selected resource that has a lowest sub-priority, as compared to the resources that are already allocated to the first requesting partition.

19. The storage medium of claim 12, further comprising:
receiving a packet from a network;
determining that data in the packet matches the tuple; and
storing the packet in the queue specified by the mapping.

20. The storage medium of claim 12, further comprising:
receiving a deallocation request from the first requesting partition;
selecting a first saved request from among a plurality of saved requests, wherein the first saved request was previously received from a second requesting partition and saved at a time when all of the plurality of resources were allocated and could not be preempted; and
allocating the selected resource to the second requesting partition.

21. The storage medium of claim 20, wherein the selecting the first saved request further comprises:
selecting a highest priority of the plurality of saved requests;
selecting a second selected partition that has a lowest percentage of its upper limit of the plurality of resources allocated at the highest priority; and
selecting the first saved request that was sent by the second selected partition that has a highest sub-priority.

22. The storage medium of claim 12, further comprising:
setting a plurality of upper limits of numbers of the plurality of resources that the requesting partition is allowed to allocate at a plurality of priorities.

23. A computer comprising:
a processor;
memory communicatively connected to the processor, wherein the memory encodes instructions, wherein the instructions when executed by the processor comprise
receiving a first allocation request from a first requesting partition, wherein the first allocation request comprises a tuple and an identifier of a queue,
deciding that all of a plurality of resources are allocated,
in response to the deciding, selecting a selected resource from among the plurality of resources, wherein the selected resource is allocated to a selected partition; and
a network adapter communicatively connected to the processor, wherein the network adapter comprises logic and the plurality of resources, and wherein the logic allocates the selected resource to the first requesting partition by storing a mapping of the tuple to the first queue into the selected resource.

24. The computer of claim 23, wherein the first allocation request further comprises a first priority, wherein the selected partition sent a second allocation request comprising a second priority, and wherein the selecting further comprises:
determining that the first priority is greater than the second priority; and
determining that the selected partition is allocated a greatest percentage of its allocated resources at the second priority, as compared to percentages of the resources allocated at the second priority to other of a plurality of partitions.

25. The computer of claim 24, wherein the selecting further comprises:
selecting the second priority to be a lowest priority of the plurality of resources.

26. The computer of claim 25, wherein the selecting further comprises:
selecting the selected resource with a lowest sub-priority of the resources that are allocated to the selected partition.

27. The computer of claim 23, wherein the first allocation request further comprises a first priority, wherein the selected partition sent a second allocation request comprising a second priority, and wherein the selecting further comprises:
determining that the first priority is less than or equal to priorities of all of the plurality of resources that are currently allocated; and
determining that the first requesting partition has a less percentage of its upper limit of a number of the plurality of resources at the first priority than does the selected partition at the second priority, wherein the first priority and the second priority are equal.

28. The computer of claim 27, wherein the selecting further comprises:
selecting the selected resource with a lowest sub-priority that is assigned to the resources that are allocated to the selected partition.

29. The computer of claim 23, wherein the first allocation request further comprises a first priority, and wherein the selecting further comprises:
determining that the first priority is less than or equal to priorities of all of the plurality of resources that are currently allocated;
determining that the first requesting partition has a greater percentage of its upper limit of a number of the plurality of resources allocated at the first priority than do all other partitions of their upper limits at the first priority; and
selecting the selected resource that has a lowest sub-priority, as compared to the resources that are already allocated to the first requesting partition.

30. The computer of claim 23, wherein the logic further receives a packet from a network, stores the packet in the first queue specified by the mapping if data in the packet matches the tuple, and stores the packet in a default queue associated with a logical port specified by the packet if the data in the packet does not match the tuple.

31. The computer of claim 23, wherein the instructions further comprise:
receiving a deallocation request from the first requesting partition, and
selecting a first saved request from among a plurality of saved requests, wherein the first saved request was previously received from a second requesting partition and saved at a time when all of the plurality of resources were allocated and could not be preempted; and
wherein the logic further allocates the selected resource to the second requesting partition.

32. The computer of claim 31, wherein the selecting the first saved request further comprises:
selecting a highest priority of the plurality of saved requests;
selecting a second selected partition that has a lowest percentage of its upper limit of the plurality of resources allocated at the highest priority; and
selecting the first saved request that was sent by the second selected partition that has a highest sub-priority.

33. The computer of claim 23, wherein the instructions further comprise:
setting a plurality of upper limits of numbers of the plurality of resources that the requesting partition is allowed to allocate at a plurality of priorities.
